(19) United States
(12) Patent Application Publication
(10) Pub. No.: US 2015/0205452 A1
(43) Pub. Date: Jul. 23, 2015

(54) METHOD, APPARATUS AND INTERACTIVE INPUT SYSTEM

(71) Applicant: SMART TECHNOLOGIES ULC, Calgary (CA)

(72) Inventor: DAVID POPOVICH, Calgary (CA)

(73) Assignee: SMART TECHNOLOGIES ULC, Calgary (CA)

(21) Appl. No.: 14/600,414

(22) Filed: Jan. 20, 2015

Related U.S. Application Data
(60) Provisional application No. 61/929,971, filed on Jan. 21, 2014.

(51) Int. Cl. G06F 3/0481; G06F 3/0488; G09B 5/02; G06F 3/0484

(52) U.S. Cl. CPC G06F 3/0481; G06F 3/04842; G06F 3/04883; G09B 5/02

(57) ABSTRACT

A method comprises mapping elements of an image on a digitizer surface to functions of a widget executed on a computing device that communicates with the digitizer; and responsive to user interaction with the elements, executing the widget functions mapped to the elements.

### CROSS-REFERENCE TO RELATED APPLICATION

This application claims the benefit of U.S. Provisional Application No. 61/929,971 to Popovich, filed on Jan. 21, 2014, entitled “Method, Apparatus and Interactive Input System”, the entire disclosure of which is incorporated herein by reference.

### FIELD

The subject application relates generally to a method, apparatus and interactive input system.

### BACKGROUND

Interactive input systems that allow users to inject input such as for example digital ink, mouse events etc. into an application program using an active pointer (eg. a pointer that emits light, sound or other signal), a passive pointer (e.g., a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001, all assigned to SMART Technologies ULC of Calgary, Alberta, Canada, assignee of the subject application, the entire disclosures of which are incorporated herein by reference; touch systems comprising touch panels employing electromagnetic, capacitive, acoustic or other technologies to register pointer input; tablet and laptop personal computers (PCs); personal digital assistants (PDAs) and other handheld devices; and other similar devices.

In educational environments, lessons involving the creation of physical devices on paper such as laptop computers, calculators, televisions etc. have been held. During such lessons, students are asked to design on paper a physical device, giving the students the freedom to bend the rules of conventional design and focus the design on personal choice and creativity rather than on practical layout and placement in terms of function. While these lessons promote creative thinking, enhancing the impact of these lessons is desired.

It is therefore an object to provide a novel method, apparatus and interactive input system.

### SUMMARY

Accordingly, in one aspect there is provided a method comprising mapping elements of an image on a digitizer surface to functions of a widget executed on a computing device that communicates with said digitizer; and responsive to user interaction with the elements, executing the widget functions mapped to the elements.

In one embodiment, the method further comprises displaying the result of the executed widget functions on the digitizer surface. The mapping comprises associating with the elements to corresponding widget functions and tracing the elements on the digitizer surface. The associating comprises, for each element, selecting a graphical object displayed on the digitizer surface associated with the corresponding widget function prior to the tracing.

The method may further comprise, prior to the mapping, placing the image on the digitizer surface within a designated region. The designated region may be a specified area within a window displayed on the digitizer surface. The image may be one of a hand-drawn image on a substrate, a picture, photograph or other illustration on a substrate or a digital image.

According to another aspect there is provided an apparatus comprising memory; one or more processors communicating with said memory, said one or more processors executing program instructions stored in said memory to cause said apparatus at least to: map elements of an image on a digitizer surface to functions of a widget executed on a computing device that communicates with said digitizer; and responsive to user interaction with the elements, execute the widget functions mapped to the elements.

According to another aspect there is provided a non-transitory computer readable medium embodying executable program code, said program code when executed by one or more processors, causing an apparatus to carry out a method comprising mapping elements of an image on a digitizer surface to functions of a widget executed on a computing device that communicates with said digitizer; and responsive to user interaction with the elements, executing the widget functions mapped to the elements.

According to another aspect there is provided an interactive input system comprising a digitizer having an interactive surface on which a computer-generated image is presented; and processing structure communicating with said digitizer, said processing structure executing an application program that causes said processing structure to: map elements presented on said interactive surface to corresponding functions of said application program; execute, in response to user interaction with the elements, the corresponding application functions; and update the computer-generated image presented on the interactive surface in accordance with the executed application functions.

### BRIEF DESCRIPTION OF THE DRAWINGS

Embodiments will now be described more fully with reference to the accompanying drawings in which:

FIG. 1 is a perspective view of an interactive input system;

FIG. 2 is a simplified block diagram of the software architecture of a general purpose computing device forming part of the interactive input system of FIG. 1; and

FIGS. 3 to 7 show screens presented on an interactive surface of an interactive board forming part of the interactive input system of FIG. 1 during execution of a widget.

### DETAILED DESCRIPTION OF EMBODIMENTS

In the following, a method, apparatus, non-transitory computer-readable medium and interactive input system are described wherein the method comprises mapping elements in an image on a digitizer surface to functions of a widget executed on a computing device that communicates with said digitizer; and responsive to user interaction with the elements, executing the widget functions mapped to the elements.

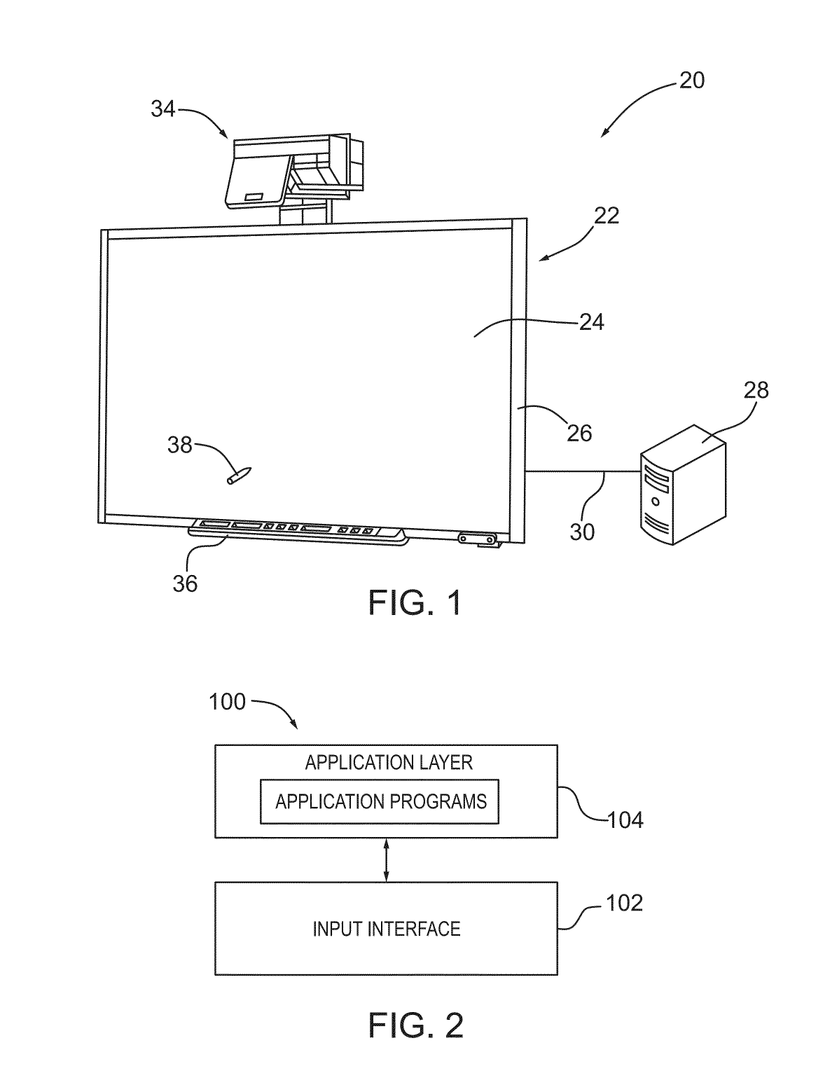

Turning now to FIG. 1, an interactive input system is shown and is generally identified by reference numeral 20. Interactive input system 20 allows one or more users to inject input such as digital ink, mouse events, commands, etc. into an executing application program. In this embodiment, interactive input system 20 comprises a digitizer in the form of an interactive board 22 mounted on a vertical support surface such as for example, a wall surface or the like. Interactive board 22 comprises a generally planar, rectangular interactive surface 24 that is surrounded about its periphery by a bezel 26. An ultra-short-throw projector 34, such as that sold by SMART Technologies ULC under the name “SMART UX60”, is also mounted on the support surface above the interactive board 22 and projects a computer-generated image, such as for example, a computer desktop, onto the interactive surface 24.

The interactive board 22 employs machine vision to detect one or more pointers brought into a region of interest in proximity with the interactive surface 24. The interactive board 22 communicates with a general purpose computing device 28 executing one or more application programs via a universal serial bus (USB) cable 30 or other suitable wired or wireless communication link. General purpose computing device 28 processes the output of the interactive board 22 and adjusts image data that is output to the projector 34, if required, so that the image presented on the interactive surface 24 reflects pointer activity. In this manner, the interactive board 22, general purpose computing device 28 and projector 34 allow pointer activity proximate to the interactive surface 24 to be recorded as writing or drawing or used to control execution of one or more application programs executed by the general purpose computing device 28.

The bezel 26 is mechanically fastened to the interactive surface 24 and comprises four bezel segments that extend along the edges of the interactive surface 24. In this embodiment, the inwardly facing surface of each bezel segment comprises a single, longitudinally extending strip or band of retro-reflective material. To take best advantage of the properties of the retro-reflective material, the bezel segments are oriented so that their inwardly facing surfaces lie in a plane generally normal to the plane of the interactive surface 24.

A tool tray 36 is affixed to the interactive board 22 adjacent the bottom bezel segment using suitable fasteners such as for example, screws, clips, adhesive etc. As can be seen, the tool tray 36 comprises a housing having an upper surface configured to define a plurality of receptacles or slots. The receptacles are sized to receive one or more pen tools 38 as well as an eraser tool that can be used to interact with the interactive surface 24. Control buttons are also provided on the upper surface of the tool tray housing to enable a user to control operation of the interactive input system 20. Further specifies of the tool tray 36 are described in International PCT Application Publication No. WO 2011/085486 filed on Jan. 13, 2011, and entitled “INTERACTIVE INPUT SYSTEM AND TOOL TRAY THEREFOR”.

Imaging assemblies (not shown) are accommodated by the bezel 26, with each imaging assembly being positioned adjacent a different corner of the bezel. Each of the imaging assemblies comprises an image sensor and associated lens assembly that provides the image sensor with a field of view sufficiently large as to encompass the entire interactive surface 24. A digital signal processor (DSP) or other suitable processing device sends clock signals to the image sensor causing the image sensor to capture image frames at the desired frame rate. During image frame capture, the DSP also causes an infrared (IR) light source to illuminate and flood the region of interest over the interactive surface 24 with IR illumination. Thus, when no pointer exists within the field of view of the image sensor, the image sensor sees the illumination reflected by the retro-reflective bands on the bezel segments and captures image frames comprising a continuous bright band. When a pointer exists within the field of view of the image sensor, the pointer occludes IR illumination and appears as a dark region interrupting the bright band in captured image frames.

The imaging assemblies are oriented so that their fields of view overlap and look generally across the entire interactive surface 24. In this manner, any pointer such as for example a user's finger, a cylinder or other suitable object, a pen tool 38 or an eraser tool lifted from a receptacle of the tool tray 36, that is brought into proximity of the interactive surface 24 appears in the fields of view of the imaging assemblies and thus, is captured in image frames acquired by multiple imaging assemblies. When the imaging assemblies acquire image frames in which a pointer exists, the imaging assemblies convey pointer data to the general purpose computing device 28.

The general purpose computing device 28 in this embodiment is a personal computer or other suitable processing device comprising, for example, a processing unit comprising one or more processors, system memory (volatile and/or non-volatile memory), other non-removable or removable memory (e.g., a hard disk drive, RAM, ROM, EEPROM, CD-ROM, DVD, flash memory, etc.) and a system bus coupling the various computing device components to the processing unit. The general purpose computing device 28 may also comprise networking capabilities using Ethernet, WiFi, and/or other suitable network format, to enable connection to shared or remote drives, one or more networked computers, or other networked devices.

The general purpose computing device 28 processes pointer data received from the imaging assemblies to resolve pointer ambiguity by combining the pointer data generated by the imaging assemblies, and to compute the locations of pointers proximate the interactive surface 24 using well known triangulation. The computed pointer locations are then recorded as writing or drawing or used as input commands to control execution of an application program as described above.

FIG. 2 shows an exemplary software architecture used by the general purpose computing device 28, and which is generally identified by reference numeral 100. The software architecture 100 comprises an input interface 102, and an application layer comprising an application program 104. The input interface 102 is configured to receive input from the interactive board 22. The input interface 102 processes each input received to generate an input event.

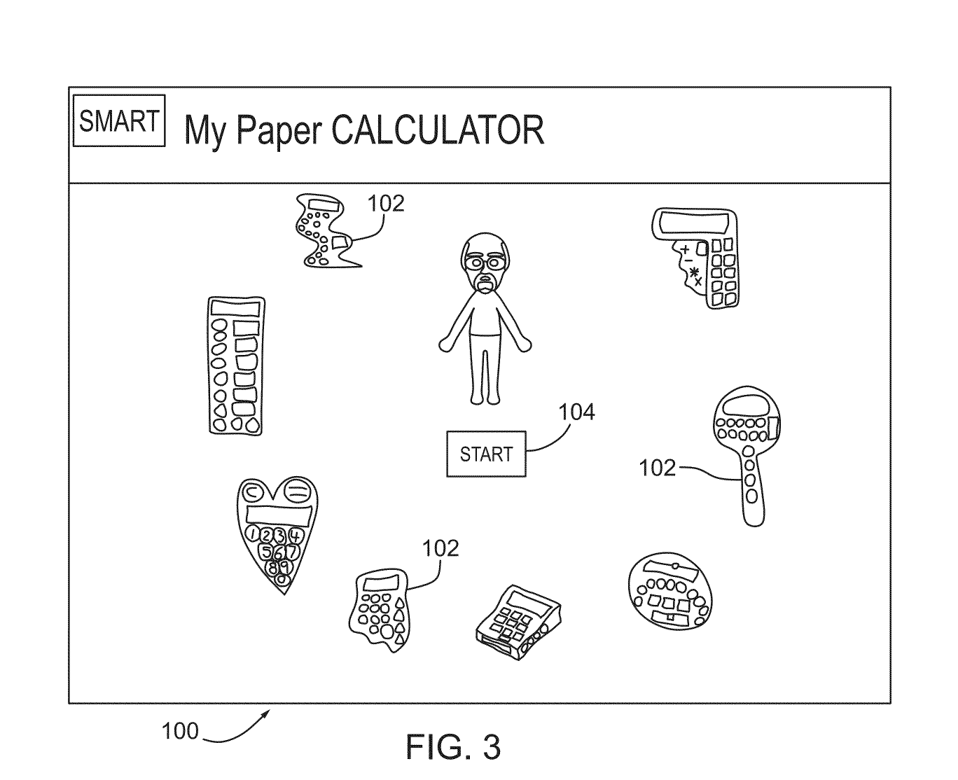

In this embodiment, one of the application programs executed by the general purpose computing device 28 is a widget that allows an image comprising functional elements to be placed on the interactive surface 24 and then pre-canned functions of the widget to be assigned to the functional elements in the image so that user interactions with the functional elements in the image invoke the assigned pre-canned functions. An exemplary widget in the form of a “My Paper CALCULATOR” application will now be described with particular reference to FIGS. 3 to 7.

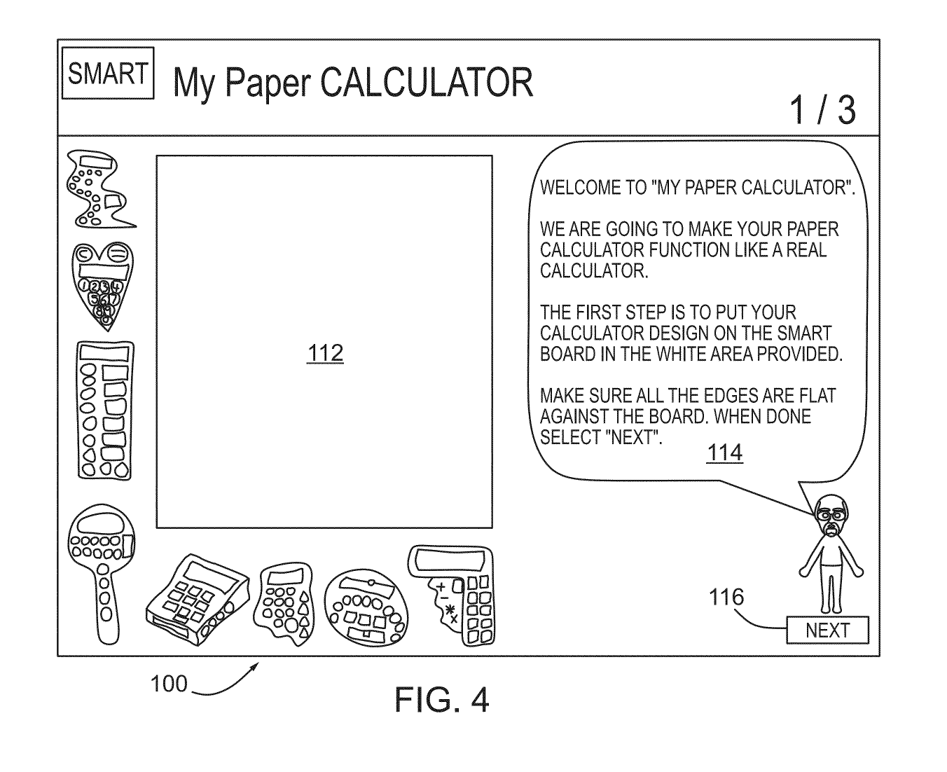

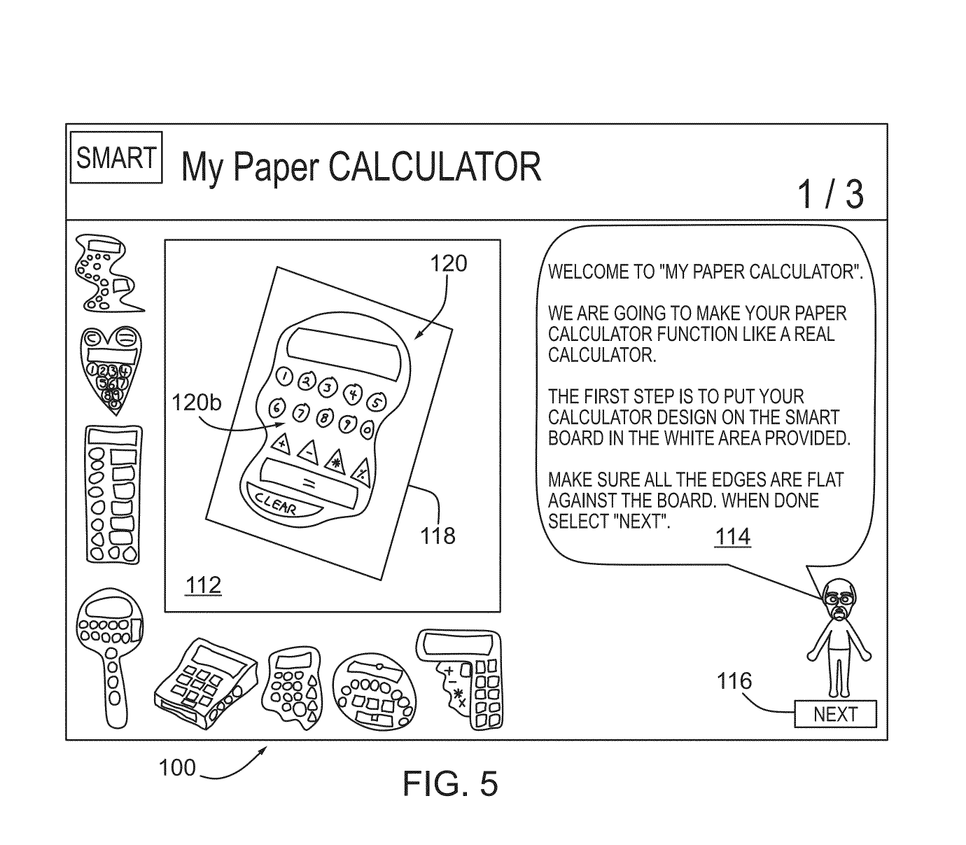

Initially, when the “My Paper CALCULATOR” application is executed by the general purpose computing device 28, a window comprising start screen 100 is presented on the interactive surface 24 as shown in FIG. 3. Start screen 100 in this embodiment comprises a plurality of images 102 of exemplary hand-drawn calculators surrounding a start button 104. When the start button 104 is selected by the user via pointer interaction with the interactive surface 24, a welcome screen 110 is presented in the window as shown in FIG. 4. As can be seen, the welcome screen 110 comprises a designated region 112 in the form of a rectangular white or light area within which a substrate in the form of a piece of paper having a hand-drawn calculator thereon is to be placed. The welcome screen 110 also comprises instructions 114 directing the user to place the piece of paper on the interactive surface 24 within the bounds of the designated region 112. In this embodiment, as the interactive board 22 employs imaging assemblies looking generally across the interactive surface 24, the instructions also direct the user to ensure that the piece of paper is pressed flat against the interactive surface 24 to inhibit the piece of paper from occluding any portion of the retro-reflective surfaces of the bezel 26 and being inadvertently recognized as pointer input. The welcome screen 110 also comprises a “Next” button 116 that is to be selected by the user after the piece of paper has been properly positioned within the designated region 112. FIG. 5 shows the welcome screen 110 with a piece of paper 118 having a hand-drawn calculator 120 thereon properly positioned within the designated region 112. As can be seen, the hand-drawn calculator 120 comprises a plurality of elements, namely a screen 120a and an array of buttons generally identified by reference numeral 120b.

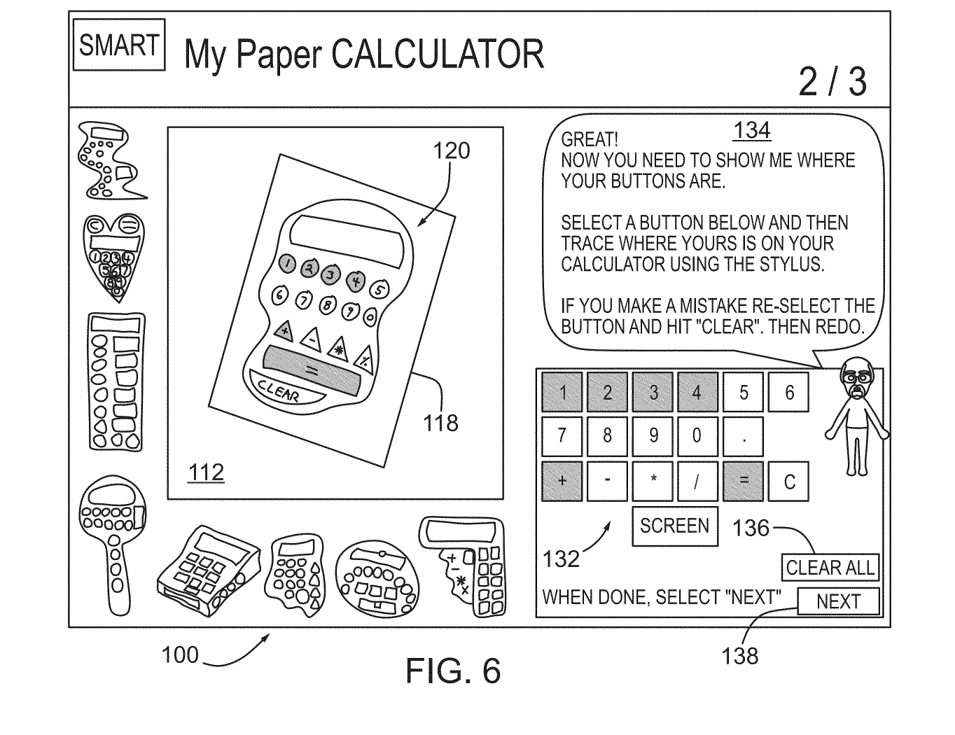

After the user has properly positioned the piece of paper 118 within the designated region 112 and has selected the “Next” button 116, a calculator configuration screen 130 is presented in the window as shown in FIG. 6. As can be seen, the calculator configuration screen 130 comprises a plurality of selectable graphic objects generally identified by reference numeral 132. In this example, the selectable objects 132 comprise numeral objects labeled zero (0) to nine (9), arithmetic operation objects labeled “+”, “−”, “*”, “I” and “=”, a clear command object labeled “C” and a screen object labeled “Screen”. Each selectable graphic object 132 is associated with a pre-canned function of the widget and can be used to assign its pre-canned function to an element of the hand-drawn calculator 120 as will be described. As will be appreciated, in this embodiment, the pre-canned functions correspond to functions of a typical calculator. In addition, the calculator configuration screen 130 comprises instructions 134 directing the user to select a graphic object 132 and then trace the corresponding element of the hand-drawn calculator 120 using a pointer and to repeat the process for all of the graphic object-corresponding hand-drawn calculator element pairs. During this process, the traced region on the interactive surface 24 corresponding to each hand-drawn calculator element is mapped to the pre-canned function assigned to the associated graphic object 132. Once a graphic object 132 has been selected and the corresponding element of the hand-drawn calculator 120 traced, the color of the selected graphic object 132 is changed to provide a visual cue to the user signifying that the pre-canned function assigned to the graphic object 132 has been mapped to an element of the hand-drawn calculator 120. The calculator configuration screen 130 also comprises a “Clear All” button 136 that can be selected to allow the mappings to be erased and the above process to be re-performed as well as a “Next” button 138 that is to be selected, once the above calculator configuration procedure has been completed.

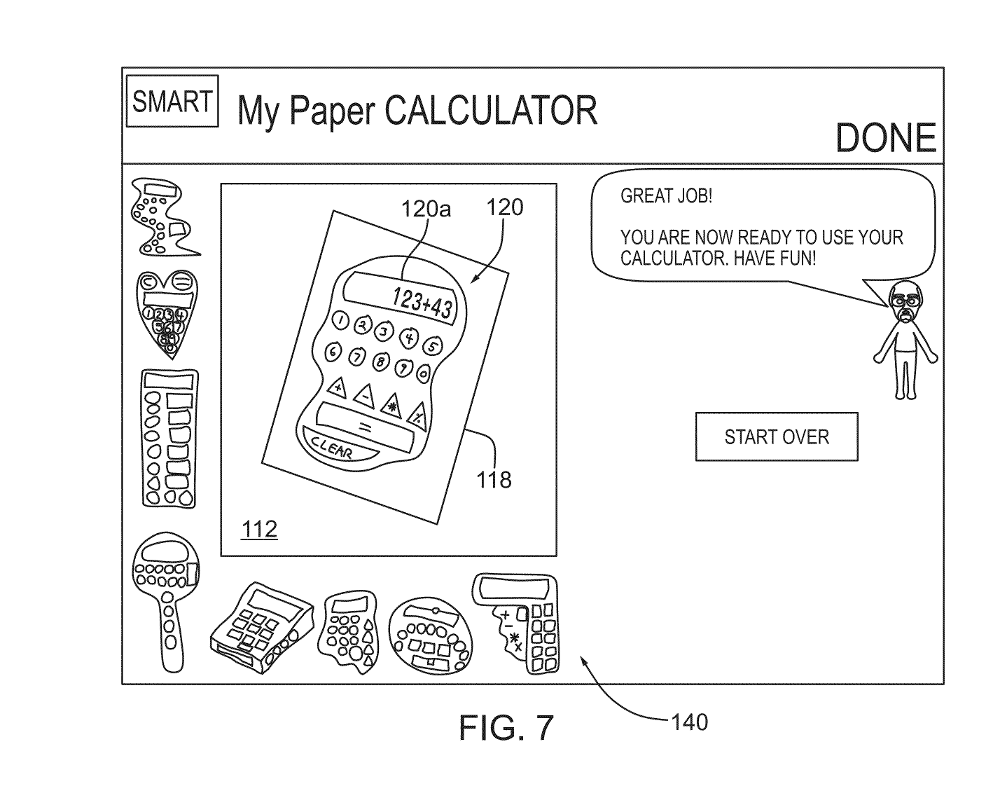

Once the calculator configuration procedure has been completed and the “Next” button 138 has been selected, a calculator initialization screen 140 is presented in the window as shown in FIG. 7 that allows the user to interact with the hand-drawn calculator 120. As a result of the hand-drawn calculator element-widget pre-canned function mappings, the hand-drawn calculator 120 is effectively “brought to life” so that user interactions with the hand-drawn calculator elements cause corresponding functions to be invoked allowing the hand-drawn calculator 120 to function like a typical calculator. For example, when the user touches the interactive surface 24 at a location corresponding to a numerical button of the hand-drawn calculator 120, the number assigned to the numerical button is displayed on the interactive surface 24 in a region corresponding to the traced screen 120a of the hand-drawn calculator 120. When the user touches the interactive surface 24 at a location corresponding one of the “+”, “−”, “*” and “I” arithmetic operation buttons of the hand-drawn calculator 120, the arithmetic operator assigned to the arithmetic operator button is displayed on the interactive surface 24 in the region corresponding to the traced screen 120a of the hand-drawn calculator 120. In the example of FIG. 7, the mathematical expression “123+43” is displayed on the interactive surface 24 in the region corresponding to the traced screen 120a of the hand-drawn calculator 120 as a result of the user making a series of touches on the interactive surface 24 at locations corresponding to the buttons of the hand-drawn calculator 120 assigned to these functions. When the user touches the interactive surface 24 at a location corresponding the “=” arithmetic operator button of hand-drawn calculator 120, if a mathematical expression is displayed on the interactive surface 24 in the region corresponding to the traced screen 120a of the hand-drawn calculator 120, the mathematical expression is solved and the result is displayed on the interactive surface 24 in the region corresponding to the traced screen 120a of the hand-drawn calculator 120.

As will be appreciated, the “My Paper CALCULATOR” widget allows a hand-drawn calculator to be virtually augmented by placing the hand-drawn calculator 120 on the interactive surface 24. While a “My Paper CALCULATOR” widget has been described above, those of skill in the art will appreciate that other widgets may be employed, where it is desired to bring an image of a physical device to life. For example, the widget may alternatively comprise pre-canned functions associated with a television, radio, clock, telephone, game controller, boom box, thermostat etc. allowing images of these physical devices to be brought to life.

If desired, the selectable graphic objects 132 may include a body button corresponding to the body or perimeter of the hand-drawn calculator 120 or other widget. Also, if desired, the general purpose computing device 28 may store the relative positions of the selectable graphic objects 132 and may include a redraw button. This permits quick re-orientation or bringing of the hand-drawn calculator 120 “back to life” should the substrate separate from the interactive surface 24 and require reaffixing, or should the substrate be rotated or moved relative to the interactive surface 24. In this case, only a subset of the elements of the hand-drawn calculator 120 may need to be traced. For example, just tracing the screen 120a of the hand-drawn calculator 120 may be sufficient to re-orient the hand-drawn calculator.

In the embodiments described above, although a piece of paper on which a calculator is hand drawn is described as being placed on the interactive surface 24, those of skill in the art will appreciate that variations are available. For example, the image need not be hand drawn and the substrate need not be a piece of paper. The image may be in the form of a picture, photograph or other illustration that is printed, adhered, taped or otherwise applied or secured to the substrate and the substrate may be formed of any suitable material on which an image can be placed.

The application program may comprise program modules including routines, instruction sets, object components, data structures, and the like, and may be embodied as computer readable program code stored on a non-transitory computer readable medium. The non-transitory computer readable medium is any data storage device that can store data. Examples of non-transitory computer readable media include for example read-only memory, random-access memory, CD-ROMs, magnetic tape, USB keys, flash drives and optical data storage devices. The computer readable program code can also be distributed over a network including coupled computer systems so that the computer readable program code is stored and executed in a distributed fashion.

Although in embodiments described above, the digitizer is described as comprising machine vision to register pointer input, those skilled in the art will appreciate that digitizers employing other machine vision configurations, analog resistive, electromagnetic, capacitive, acoustic or other technologies to register input may be employed. The digitizer need not be mounted on a wall surface. The digitizer may be suspended or otherwise supported in an upright orientation or may be arranged to take on an angled or horizontal orientation.

In embodiments described above, a projector is employed to project the computer-generated image onto the interactive surface 24. Those of skill in the art will appreciate that alternatives are available. For example, the digitizer may comprise a display panel such as for example a liquid crystal display (LCD) panel, a plasma display panel etc. on which the computer-generated image is presented. In this case, using a transparent or translucent material for the substrate is preferred to ensure the image presented on the display panel is clearly visible through the substrate and not occluded thereby.

In other embodiments, no physical substrate is used. In these embodiments, rather than place a substrate having an image thereon on the interactive surface 24, a digital image is selected from a gallery of images and placed in the designated region 112. Once the digital image is placed in the designated region 112, the digital image can be “brought to life”, in the same manner as described above. An added advantage of using digital images is that once the elements of the digital image have been traced and assigned pre-canned widget functions, as the display of the digital image is under the control of general purpose computing device 28, rotation, scaling and movement of the digital image is possible without losing the functions mapped to the elements of the digital image.

Although embodiments have been described above with reference to the accompanying drawings, those of skill in the art will appreciate that variations and modifications may be made without departing from the scope thereof as defined by the appended claims.

What is claimed is:

1. A method comprising:
mapping elements of an image on a digitizer surface to functions of a widget executed on a computing device that communicates with said digitizer; and
responsive to user interaction with the elements, executing the widget functions mapped to the elements.

2. The method of claim 1 further comprising displaying the result of the executed widget functions on said digitizer surface.

3. The method of claim 1 wherein said mapping comprises associating the elements to corresponding widget functions and tracing the elements on said digitizer surface.

4. The method of claim 3 wherein said associating comprises, for each element, selecting a graphical object displayed on said digitizer surface associated with the corresponding widget function prior to said tracing.

5. The method of claim 1 further comprising, prior to said mapping, placing the image on said digitizer surface within a designated region.

6. The method of claim 5 wherein said designated region is a specified area within a window displayed on said digitizer surface.

7. The method of claim 1 wherein said image is one of a hand-drawn image on a substrate, a picture, photograph or other illustration on a substrate and a digital image.

8. An apparatus comprising:
memory;
one or more processors communicating with said memory, said one or more processors executing program instructions stored in said memory to cause said apparatus at least to:
map elements of an image on a digitizer surface to functions of a widget executed on a computing device that communicates with said digitizer; and
responsive to user interaction with the elements, execute the widget functions mapped to the elements.

9. The apparatus of claim 8 wherein said one or more processors further cause said apparatus to display the result of the executed widget functions on said digitizer surface.

10. The apparatus of claim 8 wherein said apparatus performs said mapping in response to user input that associates the elements to the corresponding widget functions and user input that traces the elements on said digitizer surface.

11. The apparatus of claim 10 wherein the user input that associates the elements to the corresponding widget functions comprises, for each element, selection of a graphical object displayed on said digitizer surface associated with the corresponding widget function.

12. The apparatus of claim 8 wherein the image is placed on said digitizer surface within a designated region.

13. The apparatus of claim 12 wherein said designated region is a specified area within a window displayed on said digitizer surface.

14. The apparatus of claim 8 wherein said image is one of a hand-drawn image on a substrate, a picture, photograph or other illustration on a substrate and a digital image.

15. The apparatus of claim 8 further comprising said digitizer.

16. A non-transitory computer readable medium embodying executable program code, said program code when executed by one or more processors, causing an apparatus to carry out a method comprising:
mapping elements of an image on a digitizer surface to functions of a widget executed on a computing device that communicates with said digitizer; and
responsive to user interaction with the elements, executing the widget functions mapped to the elements.

17. An interactive input system comprising:
a digitizer having an interactive surface on which a computer-generated image is presented; and
processing structure communicating with said digitizer, said processing structure executing an application program that causes said processing structure to:
map elements presented on said interactive surface to corresponding functions of said application program;
execute, in response to user interaction with the elements, the corresponding application functions; and
update the computer-generated image presented on the interactive surface in accordance with the executed application functions.

18. The interactive input system of claim 17 wherein said processing structure performs said mapping in response to user input entered on said interactive surface that associates the elements to the corresponding application functions and user input entered on said interactive surface that traces the elements.

19. The interactive input system of claim 18 wherein the user input that associates the elements to the corresponding application functions comprises, for each element, selection of a graphical object of said computer-generated image associated with the corresponding widget function.

20. The interactive input system of claim 17 wherein the image is placed on said interactive surface within a designated region.

21. The interactive input system of claim 20 wherein said designated region is a specified area within said computer-generated image.

22. The interactive input system of claim 17 wherein said image is one of a hand-drawn image on a substrate, a picture, photograph or other illustration on a substrate and a digital image.

23. The interactive input system of claim 17 further comprising one or more projectors for projecting the computer-generated image onto said interactive surface.

24. The interactive input system of claim 17 wherein said digitizer comprises a display panel having a display surface on which the computer-generated image is presented.
